(19) United States
(12) Patent Application Publication
(10) Pub. No.: US 2007/0118527 A1
(43) Pub. Date: May 24, 2007

(54) Security and data filtering

(75) Inventors: Paul R. Winje, Fargo, ND (US); Michael J. Kensok, Fargo, ND (US); Lee C. Spiesman, Fargo, ND (US); Jeffrey D. Hensel, Fargo, ND (US); Jaroslaw Wyganowski, Fargo, ND (US); Brian K. Gullickson, Hudson, WI (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/284,647

(22) Filed: Nov. 22, 2005

(51) Int. Cl. G06F 17/30

(52) U.S. Cl. 707/9

(57) ABSTRACT

A pluggable data filtering system allows users to access secure and non-secure data, using completely flexible filtering terms. The system provides functionality that identifies data that is both responsive to the user's search, and for which the user has been granted access rights, and automatically provides those data to the user, as filtered in accordance with the user's access rights. One particular embodiment of the pluggable data filtering system uses an interface implementation that assigns globally unique identifiers to filterable entities and filterable container entities that may be secure or non-secure, and uses detailed data access rights assigned to various user roles.

### BACKGROUND

The longtime need to organize and search for information has been advanced with data structures and software to access data. However, there has remained a persistent need for better ways of organizing and making information available, particularly where a variety of different information must have different levels of security, and be made available in different combinations to a variety of different users.

As one illustrative example, enterprise organizations, such as companies, units of government, and educational and non-profit institutions, generally have a variety of information associated with them, and a set of rules that dictate what segments of that information are available to different members of the enterprise organization. Such organizations typically require software applications and software systems to make the information available to the organization, and to track a wide variety of other information associated with the organization.

There are many situations in which a variety of different software applications and software systems are used, with separate data structures that do not interact smoothly or at all. This makes it very difficult to perform transactions between entities using such incompatible data structures. For example, in such an environment, a user that works for or with multiple different companies, departments, or other organization entities may be required to log in and log out of different database systems whenever that user wishes to change the company for which she or he is accessing data.

Other software systems allow two or more entities to share a single database. This reduces the requirement for duplicating data, but it has, in the past, required each entity to be labeled with an entity ID that is entitled to access to that business entity. In other words, every record that is shared across different companies must contain identifiers for those companies within the record itself.

Additionally, much of the data related to such organizations is sensitive in one way or another, and must be secure. Complicated requirements often arise for different users to have access rights to various data they are authorized to have access to. Furthermore, much of the data, across many different units or entities of the organization, are constantly changing. The way the different units or entities of the organization are themselves likely to change from time to time. This has often been very disruptive of different users being able to access data to which they are authorized, while ensuring that data remains secure from those who do not have authorized access.

These systems have disadvantages in themselves. They either require duplication of data, or they require painstaking manipulation of each business entity to contain company identifiers. It can thus be seen that prior systems require an undesirable amount of labor and inefficiency for users to access secure data related to large and complex organizations.

The discussion above is merely provided for general background information and is not intended to be used as an aid in determining the scope of the claimed subject matter.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

A pluggable data filtering system allows users to access secure and non-secure data using completely flexible filtering terms. The system provides functionality that identifies data that is both responsive to the user's search, and for which the user has been granted access rights, and automatically provides those data to the user, as filtered in accordance with the user's access rights.

In one embodiment, a computer-implemented method provides a user with access to data. A statement is received comprising a set of criteria selected by a user. A stored set of user access rights assigned to the user is obtained. A resulting set of data complying both with the criteria selected by the user and with the user access rights is identified. The user is then provided with access to the resulting set of data.

In another embodiment, a computer-readable medium includes computer-executable instructions which are executed by a computer, thereby configuring the computer to perform a number of steps. It provides information indicative of a data structure. It receives a data statement from a user, including data statement criteria selected by the user. It also applies further data statement criteria to the data statement based on a set of data access rights previously assigned to the user. It retrieves a set of filtered data, conforming to both the data statement criteria selected by the user and the further data statement criteria based on the user's data access rights, from the data structure. It then provides the user with access to the filtered data.

In another embodiment, a pluggable criteria provider is configured to receive statements communicated from a filtering criteria provider and an application. The pluggable criteria provider joins filter criteria from the statements to retrieve relevant data from the database and provide the data to a user according to the filter criteria. The filter criteria may include optional filters selected by the user and secure filters corresponding to the user's access rights. These filters correspond to filterable containers that link to the data.

Various embodiments provide a wealth of additional and unexpected advantages, beyond the resolution of difficulties with current solutions. A variety of other variations and embodiments besides those illustrative examples specifically discussed herein are also contemplated, and may be discerned by those skilled in the art from the entirety of the present disclosure.

### BRIEF DESCRIPTION OF THE DRAWINGS

FIG. 1 depicts a block diagram of one illustrative environment in which various embodiments can be used.

FIG. 2 depicts an architectural-level diagram of a data system, according to one embodiment.

FIG. 3 depicts a block diagram illustrating the process of associating data and users to a data structure.

FIG. 4 depicts a block diagram representing a data system, according to an illustrative embodiment.

FIG. 5 depicts a flowchart for a method according to one illustrative embodiment.

### DETAILED DESCRIPTION OF ILLUSTRATIVE EMBODIMENTS

Various embodiments disclosed herein deal with associating data and users to a data structure. More specifically, different embodiments provide a pluggable data filtering system and method for allowing a user to search for data for automatically producing data that is both responsive to the user's search and to which the user has been assigned access rights. The system therefore automatically provides the user with data that is specifically filtered according to that user's requirements. This automatic delivery of secure or non-secure data is based on a robust system that automatically maintains association of user access rights to attributes known as filterable containers, which provide filter links to attributes known as filterable entities that comprise data. The data may be associated with any kind of system; in one illustrative example, the data may be related to different units and elements of an organization, for instance. The pluggable data filtering system automatically filters data based on the user's assigned rights in the system and on additional filter criteria that may be selected by the user.

This filtering illustratively cannot be bypassed by the users, and provides data security to the critical information in the system. Furthermore, the pluggable data filtering mechanism is built generically so that it can be related to any collection of data. This generic filtering mechanism securely filters data based on filterable data containers and their linked contents, comprising filterable data entities. The generic filtering mechanism allows users to send, for example, SQL statements to the framework that apply search criteria restrictions as well as criteria restrictions incorporating the user's assigned access rights. This makes it possible to secure every request for access to data.

This generic filtering mechanism can be implemented in a variety of ways. For example, one specific implementation uses an interface that assigns a globally unique identifier known as a GUID handle to the filterable containers and filterable entities. The filtering mechanism takes into account a user's rights to different units of a data structure, default units to read or write to, secure as well as non-secure filters, combinations that filter the same entity, and other features. Various embodiments also include application programming interfaces (APIs) for this system.

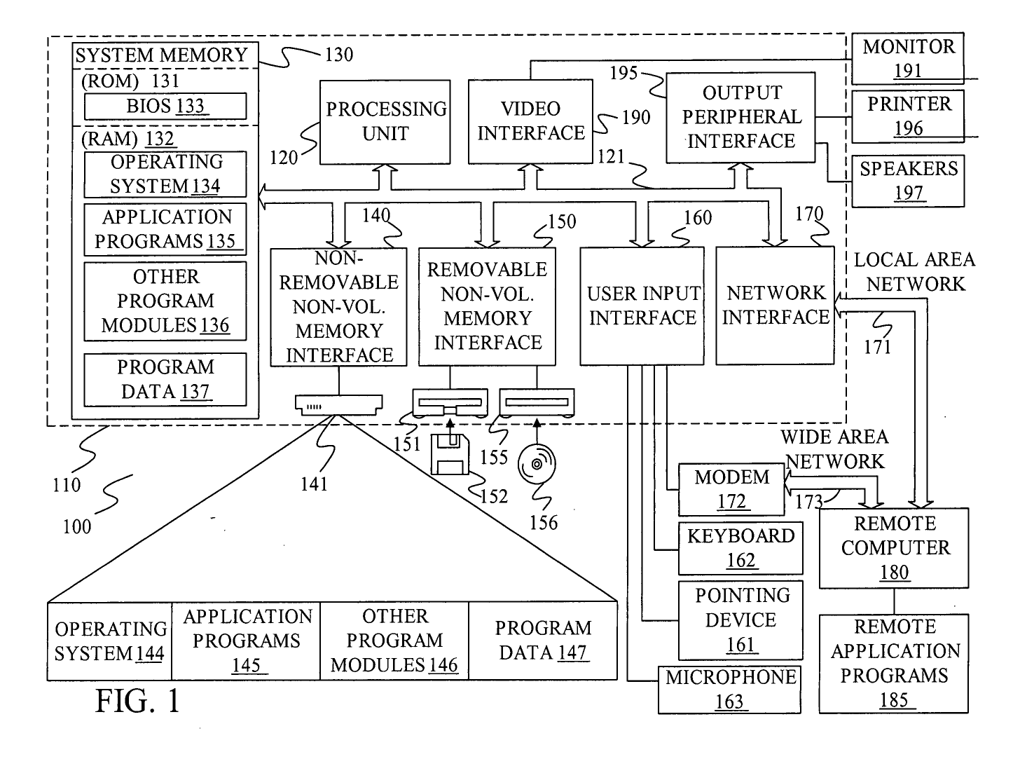

Various embodiments may run on or be associated with a wide variety of hardware and computing environment elements and systems. A computer-readable medium may include computer-executable instructions that configure a computer to run applications, perform methods, and provide systems associated with different embodiments. One illustrative example of this is depicted in FIG. 1. FIG. 1 illustrates an example of a suitable computing system environment 100 on which various embodiments may be implemented. The computing system environment 100 is only one example of a suitable computing environment and is not intended to suggest any limitation as to the scope of use or functionality of different embodiments. Neither should the computing environment 100 be interpreted as having any dependency or requirement relating to any one or combination of components illustrated in the exemplary operating environment 100.

Embodiments are operational with numerous other general purpose or special purpose computing system environments or configurations. Examples of well-known computing systems, environments, and/or configurations that may be suitable for use with various embodiments include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

Embodiments may be described in the general context of computer-executable instructions, such as program modules, being executed by a computer. Generally, program modules include routines, programs, objects, components, data structures, etc. that perform particular tasks or implement particular abstract data types. Some embodiments are designed to be practiced in distributed computing environments where tasks are performed by remote processing devices that are linked through a communications network. In a distributed computing environment, program modules are located in both local and remote computer storage media including memory storage devices.

With reference to FIG. 1, an exemplary system for implementing some embodiments includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 is operated in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

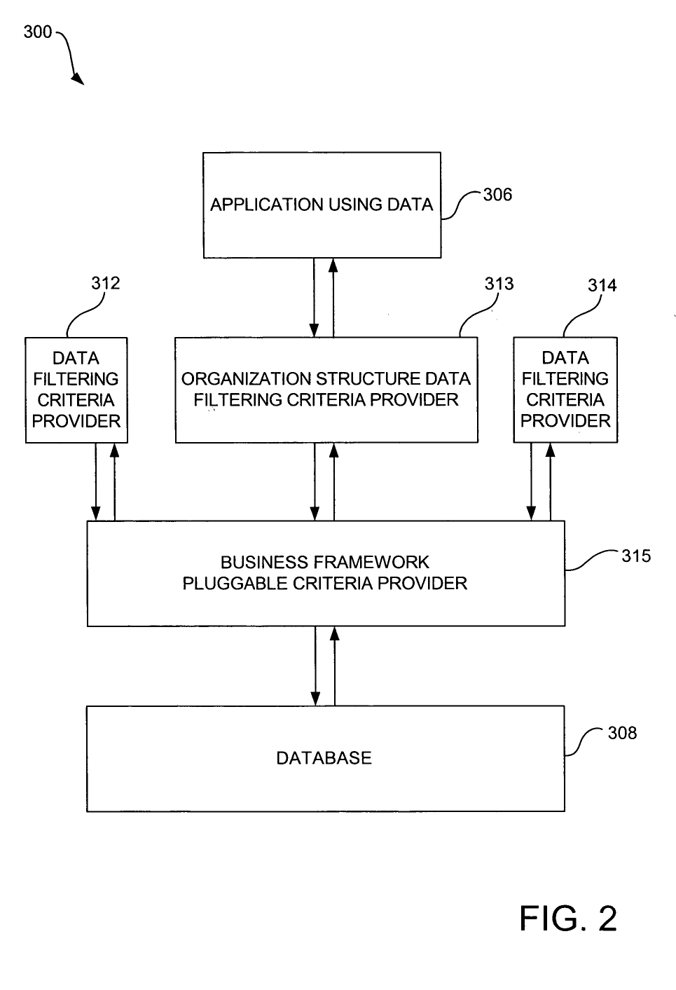

FIG. 2 is an architectural-level diagram of a data system 300, according to one embodiment. At the center of data system 300 is business framework pluggable criteria provider 315. Pluggable criteria provider 315 is comprised in a business framework layer, which runs on top of a software platform. Pluggable criteria provider 315 is in operative communication with a variety of data filtering criteria providers 312, 313, 314. These are illustrative of any number of filtering criteria providers with which pluggable criteria provider 315 may be in communication. Data filtering criteria provider 313 in particular is for an organization structure, as one illustrative example of a data filtering criteria provider with which pluggable criteria provider 315 may communicate. Other data filtering criteria providers such as 312, 314 may apply generically to any structure or application.

Data filtering criteria provider 313 is configured in operative communication with application 306 and receives queries or other statements from a user through the application 306. Application 306 is provided for a user to interact with through a desktop computer, a handheld device, or any other appropriate user interface. Filtering criteria provider 313 is configured to add additional criteria, including security filtering criteria, to statements received from application 306. Pluggable criteria provider 315 is configured in operative communication with database 308, and conveys the statements with the additional security filtering criteria to database 308.

Pluggable filtering criteria provider 315 is configured to receive the queries or other statements and the filtering criteria provided by the corresponding filtering criteria provider 313 to perform automatic filtering. The queries may, for example, take the form of SQL statements, in one illustrative embodiment. Pluggable filtering criteria provider 315 calls the data filtering criteria provider 313. Filtering criteria provider 313 then examines the entities involved in the query, and gets all the filters for each of the entities. Pluggable filtering criteria provider 315 then joins the additional criteria from the data filtering criteria provider 313 to the existing SQL query statement, and executes the joined statement, in this illustrative embodiment. The data filtering criteria provider 313 comprises information relating to filterable entities, and the pluggable criteria provider 315 acts as a filter mechanism to append or add additional criteria to the user's requested query.

For the data filtering criteria providers e.g. 312, 313, 314 to receive calls for criteria from pluggable criteria provider 315, they must be “registered” with pluggable criteria provider 315. The pluggable criteria provider 315 will call out to all data filtering criteria providers e.g. 312, 313, 314, and will keep adding additional criteria that are provided by any such registered filtering criteria providers, before executing the joined query statement. The filtering criteria providers e.g. 312, 313, 314 can register themselves by defining and implementing a static method that the framework will call at the right time (similar to an event model). Filtering criteria providers e.g. 312, 313, 314 register themselves via a config file.

The criteria providers, e.g. criteria provider 313, can also create any structure suitable to be able to pass contextual information. One illustrative example of this is a class known as the Boundary/BoundaryCollection class. This is passed to the framework, such as pluggable criteria provider 315, as an “object” when performing any data access, though it is not required to be passed. At an appropriate time, the pluggable criteria provider 315 will call out to the appropriate filtering criteria provider 313, passing the contextual “object” it was given. It will expect some criteria back that is in a form it understands. It will then take these criteria and add them to the existing criteria. Pluggable criteria provider 315 may do this for all registered filtering criteria providers e.g. 312, 313, 314.

Database 308 can, for example, be implemented as a relational database system, an object-relational database system, an object oriented database system, or any other suitable storage system. In one illustrative embodiment, database 308 includes a data store that stores data in relational tables, and a data store accessing component that receives queries or statements to the database and converts those queries or statements into relational database statements for accessing data in the data store. However, any other suitable data accessing system can be used as well.

An administrator or developer may organize data in database 308 into data structures. The administrator may then plug data into those data structures (or associate data with the data structures) at desired levels, associate the data to filterable entities if they so choose, plug users or roles of users into the data structure (or associate users or roles with the data structure) at a desired place in the data structure, and define user access rights for the users relative to filterable containers linking to the filterable entities. The administrator may opt whether or not to associate data with a secure filter, by adding a security level property to a filterable entity. In one embodiment, data added to the database 308 is automatically associated with a secure filterable entity unless the administrator chooses otherwise, so that the default is for the data to be secure.

Organization structure data filtering criteria provider 313 is one example of a criteria provider for business framework pluggable criteria provider 315. There can be many additional criteria providers for business framework pluggable criteria provider 315, as depicted with additional filtering criteria providers 312 and 314.

Business framework pluggable criteria provider 315 is contained in a business framework layer. Business framework pluggable criteria provider 315 provides the ability to apply additional criteria in an “AND” addition to a statement, such as an SQL request, received from filtering criteria provider 313, before it is sent to database 308. This can be used flexibly by a variety of applications, e.g. for organization structure filtering with filtering criteria provider 313. This provides the ability to limit the amount of data returned for security or convenience filtering purposes. This may include either secure or non-secure filters for the data.

The secure filters are set up ahead of time by the administrator as secure filter links from the filterable containers to the filterable entities, with access granted only if the user's role indicates access rights to a particular filterable container—e.g. if the filterable container is indicated in a table resulting from an inner join of the query statement, the user's role, and the globally unique identifier of the filterable container. Information indicating whether the user's role includes access rights to a particular filterable container may be passed to pluggable criteria provider 315 through a collection of boundary objects, for example. A particular illustration of this is provided below. While a user may see the filterable container itself, the user only has access to data linked from that filterable container if the user's role indicates rights to access inside that filterable container. On the other hand, a non-secure filter will ensure that the data linked via the non-secure filter is freely available, and will be provided in an inner join of the query statement and the filterable entity, regardless of the user's role. The user may include optional filters in the query statement simply for convenience, to help narrow the query to the data sought. This may function, for example, through an application programming interface (API) that passes contextual information to the pluggable criteria provider 315.

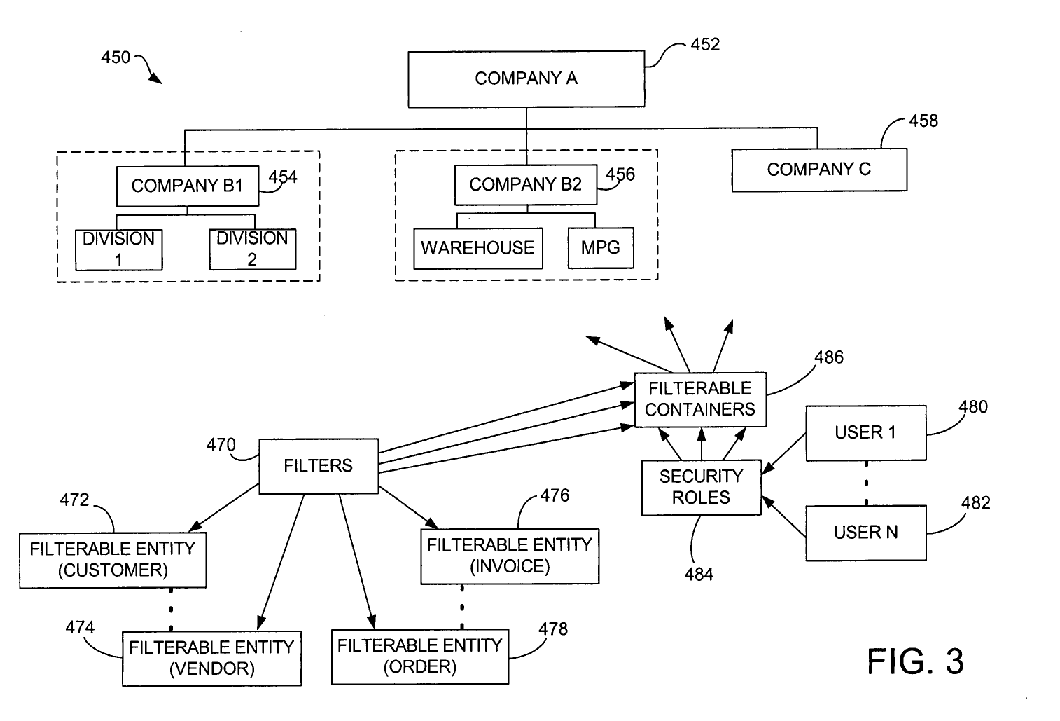

The pluggable criteria provider 315 may be configured to handle all entities in system 300, including those that are decorated with a Filterable attribute, such as a filterable entity or a filterable container. In this illustrative embodiment, data filtering criteria provider 313 automatically senses those entities that are being requested and applies security restriction criteria accordingly. Pluggable criteria provider 315 is thereby configured to retrieve data, indicated by a statement provided to it by data filtering criteria provider 313, as compiled by data filtering criteria provider 313 with an “AND” of the user's query statement and the additional criteria applied by the filtering criteria provider 313. The filtering criteria provider 313 may apply these additional criteria from a filterable entity to which the data are related, and a filterable container linking to the filterable entity, if the additional criteria added to the statement indicate access rights to that filterable entity through that filterable container. The statement may indicate access rights assigned to the user's role to a particular filterable container, in the form of more detailed access rights to filterable entities linked from the filterable container, or additional filterable criteria optionally selected by the user. The filterable entities and filterable containers are explained further below, including with respect to FIGS. 3, 4, and 5.

FIG. 3 is a block diagram illustrating the process of associating data and users to an illustrative example of a data structure—in this instance, a heirarchical organizational data structure that represents an enterprise organization. This is merely one illustration of a wide variety of potential data structures to which various embodiments of a pluggable data filtering criteria provider may be generically applied.

FIG. 3 specifically shows that illustrative filterable business entities representative of customers 472, vendors 474, invoices 476, and orders 478, comprising data pertinent to those filterable entities, are all associated with data structure 450 through a set of filters 470. In the embodiment illustrated, filters 470 can associate business entities 472-478 with data structure 450 at different levels. If one of the filters 470 associates one of the business entities 472-478 with hierarchical data structure 450 at the enterprise level, then it associates that business entity with the entire data structure 450. This can be done in a number of different ways, such as by marking the business entity as being non-filterable. This means that anyone that has access rights within the data structure 450, to data associated with any node in data structure 450, will have access to the business entity associated at the enterprise level. Therefore, such a business entity is truly a shared record, shared across the entire enterprise.

Filters 470 can also associate a business entity at the company group level. In this case, for instance, a filter 470 can associate a business entity (such as customer business entity 472) only with company B1 at node 454. In that case, any user that has access to company B1 at node 454 will be able to access that record. However, users who only have access at the enterprise level, or with different companies within data structure 450 (such as company B2 at node 456 or company C at node 458), will not have access to such a record.

The data associated with business entities 472-478 are associated through filters 470 to filterable containers 486, which are assigned to different nodes of data structure 450, and are said to be filterable on their level of association. While the particular data structure 450 depicted in FIG. 3 takes the form of a heirarchical tree, this is just one illustrative example; in other applications, the filterable containers 486 may be assigned to any variety of segments of generic data structures.

Having assigned data to the data structure 450, users can now be assigned to data structure 450, and their user access rights to the data associated with data structure 450 defined. In one illustrative embodiment, an administrator may assign illustrative individual user accounts 480 and 482 (identified as users 1 through n, representing any number n of users) to one or more security roles 484, defining the user access rights of each user. In one illustrative embodiment, a given role carries with it a group of user access rights. The user access rights, in turn, correspond to a set of filterable containers 486 that are linked by filter links 470 to illustrative filterable entities 472, 474, 476, 478. Thus, each role 484 defines what data a user assigned to those user access rights can view based on the particular filterable containers 486 for which that role 484 indicates access rights to.

For example, one user role may be defined which is referred to as the CEO role for company B1 at node 454. That role would then indicate access to a filterable container 486 assigned to the company B1 at node 454 in data structure 450. This would allow a user having that given role to have user access rights to all data associated with company B1 at node 454, including its divisions 460 and 462. Since the data associated at the enterprise level (associated with company A at node 452) is shared across all business units, the user having the “CEO of company B1” role would also have user access rights to data associated to data structure 450 at the enterprise level. However, if that given role was only associated with company B1 at node 454 by filterable containers 486, then the user having the “CEO of company B1” role would not have access to any other data that are only associated within filterable containers corresponding with company B2 at node 456, or company C at node 458, in this illustrative embodiment. Various other users may be assigned user access rights to any arbitrary combination of filterable containers in organization data structure 450.

A wide variety of different roles 484 may be defined, one for each of any number of users 480, 482, etc. Each user 480, 482, etc. therefore experiences an automatically role-based delivery of data from data structure 450, being provided with the data pertinent to that user's role 484, and not being delivered data that is not pertinent to that user's role or which is secured and to which that user's role does not include access rights.

The pluggable criteria provider thereby illustratively allows for a completely generic way of relating data to filterable containers, which could be used for almost any other data application, and is not limited to the illustrative examples herein such as with respect to enterprise organization data structures. The filterable entities and filterable containers are created, in this embodiment, by leveraging a Filterable attribute and a FilterableContainer attribute, which are added to entities to make them filterable entities or filterable containers, respectively. In this embodiment, both the filterable entities and the filterable containers implement an interface known as the IIdentifiable interface, which supplies each of the filterable entities and the filterable containers with a globally unique identifier (GUID) handle. A GUID is comprised of a 128-bit (16 byte) integer that is uniquely assigned to each of the filterable entities and the filterable containers, in this embodiment. These identifiers are ultimately what are stored in the join tables and are leveraged to provide the filtered data, in this embodiment.

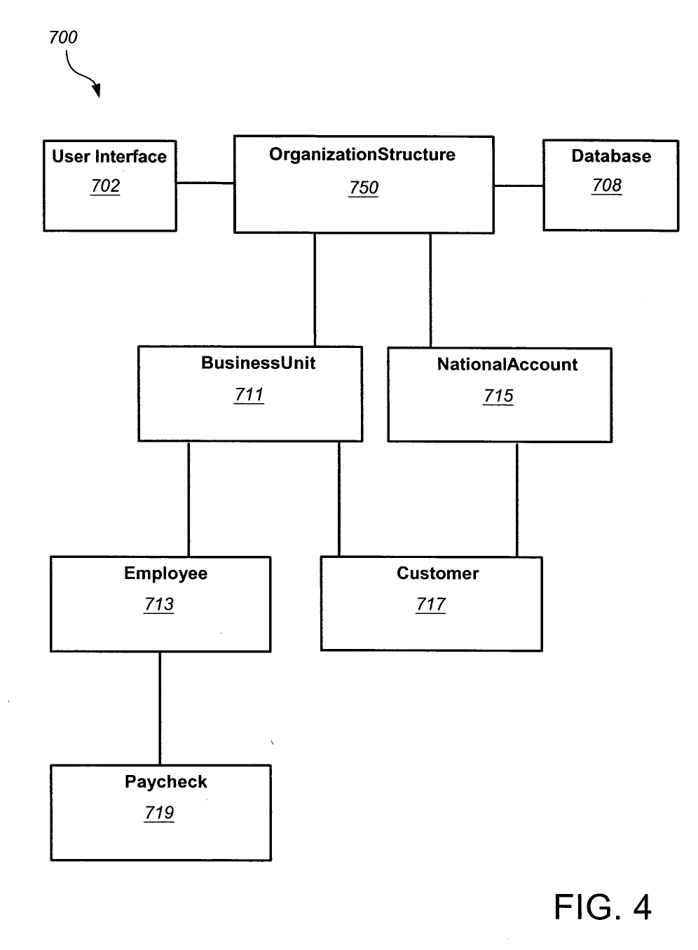

FIG. 4 depicts a block diagram representing a data system 700, highlighting the links among the filterable containers and the filterable entities, according to one illustrative embodiment. Organization data structure 750 is one illustrative data structure that may be acted upon by a pluggable criteria provider. Organization data structure 750 is operatively connected with database 708, and is accessed by a user through user interface 702. Filterable containers reside at nodes in the organization structure 750. The filterable containers have filter links to any number of filterable entities associated with components of the data system 700. These illustratively include business unit filterable containers 711 and national account filterable containers 715, representing the business units and national accounts of an enterprise organization corresponding to data structure 750. The business unit filterable containers 711 in turn each have links to any number of employee filterable entities 713, which also serve as filterable containers, and each may link to any number of paycheck filterable entities 719. This incorporates the data associated with each of the employees of each of the business units, as well as each of the paychecks of each of the employees.

The business unit filterable containers 711 and the national account filterable containers 715 also both link to any number of customer filterable entities 717. This represents the associations that might need to be represented both between business units and their customers, and between national accounts and the customers associated therewith, where any arbitrary pattern of overlapping customer relationships may characterize these associations. Data system 700 allows any arbitrary pattern of links from both any number of business unit filterable containers 711, and any number of national account filterable containers 715, to any number of customer filterable entities 717, in any arbitrary combination. Any customer account filterable entity 717 linked in data system 700 may therefore be linked from either a business unit filterable container 711, a national account filterable container 715, or both.

With respect to FIG. 2, it was noted that data filtering criteria provider 313 automatically senses entities being requested and applies security restrictions accordingly. Pluggable criteria provider 315 is thereby configured to retrieve data as indicated by criteria from data filtering criteria provider 313 and a statement from a user through application 311. The criteria from data filtering criteria provider 313 may be associated with a filterable entity, such as filterable entities 711, 713, 715, 717, or 719, for example, linked from a filterable container to which the data are related, such as filterable containers 711, 713, or 715, for example. The data filtering criteria provider 313 may automatically incorporate criteria from non-secure filterable entities, into the statement it issues; the provider 313 may also incorporate into the statement criteria from secure filterable entities, if the user's role indicates access rights to all the filterable containers linking to a filterable entity comprising the data requested. Pluggable criteria provider 315 in turn produces a joined statement as a join of criteria from data filtering criteria provider 313 and the statement from the user. Pluggable criteria provider 315 may then execute the joined statement and retrieve the data corresponding to the criteria of the joined statement.

Business framework pluggable criteria provider 315 may thereby, in one illustrative embodiment, be configured to execute a statement issued by data filtering criteria provider 313 which is based on a comparison of the access rights indicated by the additional criteria added to the statement, to a filterable container to which data requested for access in the statement are linked. Business framework pluggable criteria provider 315 may thereby also be configured to retrieve the data requested for access from data system 700.

As one example of filterable entities and filterable containers mentioned in the description of FIG. 2, a query statement to Customer filterable entity 717 could be filtered by Business Units filterable container 711 and National Accounts filterable container 715 at the same time. This might be the case, for example, for a set of user access rights assigned to a role corresponding to a mid-level manager associated with only one business unit and a portion of the total national accounts associated with the enterprise organization, so that the data filtering criteria provider 313 adds criteria to statements to filter out data from filterable entities not linked from the business unit filterable container and the national account filterable containers indicated by the user access rights assigned to that user's role. Rather, data filtering criteria provider 313 provides, in its statement to pluggable criteria provider 315, criteria for the data from filterable entities that are linked from the business unit filterable container and the national account filterable containers, as indicated by the user access rights assigned to that user's role.

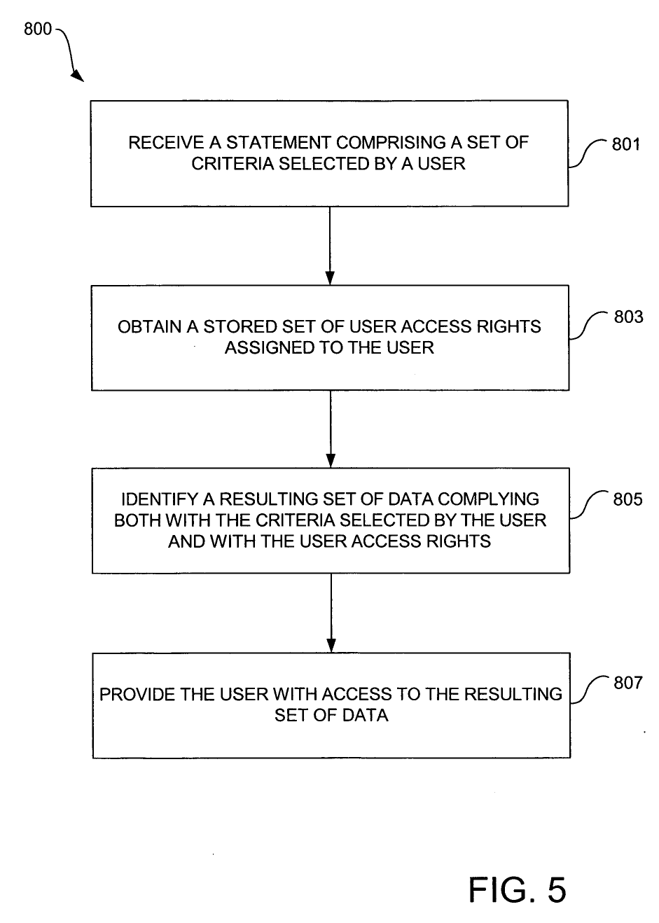

FIG. 5 illustrates additional inventive aspects, as depicted in a flowchart for a method 800 according to one exemplary embodiment. Method 800 may be implemented with a computer, such as any of various aspects of computing environment 100 depicted in FIG. 1, for example, for providing a user with access to data.

Step 801 involves receiving a statement comprising a set of criteria selected by a user. For example, the user may input a query, an insert statement, an update statement, a delete statement, or some other statement to a data system such as data system 700. Step 803 involves obtaining a stored set of user access rights assigned to the user. Step 805 is for identifying a resulting set of data complying both with the criteria selected by the user and with the user access rights. This way, the contents of the statement are responded to, but only from among data to which the user has been assigned access rights, from among data associated with filterable containers and filterable entities linked from the filterable containers in a data structure 700. Step 807 is for providing the user with access to the resulting set of data, which includes the results of returning what the user sought with the input statement, filtered according to the user access rights.

The user access rights can be assigned to any combination of the filterable containers. A user may be assigned complete, unrestricted data access rights to some filterable containers, and limited, partial data access rights to other filterable containers. These partial data access rights are assigned to the filter links linking the filterable entities from the filterable containers, in this embodiment.

Partial data access rights may include rights to add, remove, update and view information associated with filterable containers linked with the filter links. The access rights can thereby be made flexible; and by linking to the filter links, the particular rights assigned to the user are not tied to the filterable entities or the associated data themselves, in this illustrative embodiment, thereby allowing access rights management to remain easy to manage independent of any ongoing changes to the particular data associated with the filterable entities. Of course, access rights for a particular role, whether full or partial, need only be assigned where the filter links are secure. A user automatically has full access rights for information linked by non-secure filter links.

If a user's partial access rights include rights to view data linked from a particular filterable container, for example, and the user sends a query statement with criteria for viewing data linked by that filterable container, then the user is provided with access to view the data. If a query statement includes criteria for viewing data linked by a filterable container to which the user has not been assigned viewing rights, then the response provided omits any data linked from that filterable container.

Similarly, if a user sends a query statement with criteria for creating filter links to filterable entities, the user is permitted to create filter links from filterable containers to which the user's role specifies link creation. And if the user sends a statement to delete a filterable entity, the pluggable criteria provider will compare this statement with the user's deletion rights and only delete the filterable entity if the user's role indicates deletion rights to all filterable containers that link to that filterable entity.

Returning to components such as the user interface 702 or application 306 in the various embodiments as depicted, an interface is required that allows users to send statements and responsively receive access to data as specified in the statements, provided the data also complies with the user access rights indicated for the user. In one illustrative embodiment, this involves an application programming interface (API) that facilitates the ability to pass contextual information to the pluggable criteria provider 315. For example, a user could send a query statement asking for data linked from a particular filterable container, and get just the data linked from that filterable container, after it is verified that the user has appropriate access rights to that filterable containers. In one illustrative embodiment, that verifying of the user's access rights includes passing the information on the user access rights to pluggable criteria provider 315 through a collection of boundary objects.

It can thus be seen that different embodiments such as those disclosed herein provide significant advantages over current systems. Various embodiments provide a system by which a user can easily and flexibly access any data needed by that user from a data structure of arbitrary complexity, preserving the security of the data by providing only such data that each individual user has been assigned access rights to, according to the specific access rights assigned. The assigned access rights are easy to set up and maintain in their proper scope, through features such as the default access or denial of access of filterable entities linked from filterable containers to which explicit data access has been granted. These filterable container access rights assignments therefore allow the access rights to change flexibly and appropriately as the data structure is changed or reorganized. By abstracting the associations between the user roles and the data structure, this can all be done with a very low amount of data entry, or it can be done automatically, as desired. The access rights may also be augmented by more detailed explicit data access rights assignments among filterable containers. This system may be flexibly and robustly applied to virtually any system that requires manipulation of data, one example of which is a data system for an enterprise organization of arbitrarily large size and complexity.

These are indicative of a few of the various additional features and elements that may be comprised in different embodiments corresponding to the claims herein. Although particular illustrative embodiments have been selected for detailed description, workers skilled in the art will recognize that changes may be made in form and detail without departing from the spirit and scope of the invention.

What is claimed is:

1. A computer-implemented method of providing a user with access to data, comprising:
receiving a statement comprising a set of criteria selected by a user;
obtaining a stored set of user access rights assigned to the user;
identifying a resulting set of data complying both with the criteria selected by the user and with the user access rights; and
providing the user with access to the resulting set of data.

2. The computer-implemented method of claim 1, wherein the resulting set of data is identified from a data structure that comprises filterable entities and filterable containers having links to the filterable entities.

3. The computer-implemented method of claim 2, wherein the user access rights can be assigned to any combination of the filterable containers.

4. The computer-implemented method of claim 2, wherein one or more of the filterable entities have filter links to more than one filterable container, and wherein the resulting set of data provided to the user includes data from the one or more of the filterable entities only if the user access rights include rights to each of the filterable containers having links to the one or more of the filterable entities.

5. The computer-implemented method of claim 2, wherein the user access rights specify partial rights to one or more of the filterable containers.

6. The computer-implemented method of claim 5, wherein the user access rights specify rights to view data linked by one or more of the filterable containers, and the statement comprises criteria for viewing data linked by the filterable containers to which rights to view are specified in the user access rights, wherein the method comprises providing the user with access to view the data in the one or more filterable containers.

7. The computer-implemented method of claim 5, wherein the user access rights specify rights to create links associated with one or more of the filterable containers, and the statement comprises criteria for creating filter links associated with the filterable containers to which rights to create are specified in the user access rights, wherein the method comprises providing the user with access to create filter links associated with the one or more filterable containers.

8. The computer-implemented method of claim 5, wherein the user access rights specify rights to delete links associated with one or more of the filterable containers, and the statement comprises criteria for deleting one or more links associated with the filterable containers to which rights to delete are specified in the user access rights, wherein the method comprises providing the user with access to delete links associated with the one or more filterable containers.

9. The computer-implemented method of claim 2, wherein one or more of the filterable entities is secure and one or more of the filterable entities is non-secure, and identifying the resulting set of data comprises identifying data from the secure filterable entities that comply with the user access rights, and automatically identifying data from the non-secure filterable entities.

10. The computer-implemented method of claim 2, wherein the data structure represents a structure of an enterprise organization, and the filterable containers and filterable entities represent categories and elements related to the enterprise organization, indicative of the relation of the data in the filterable containers and filterable entities to the structure of the enterprise organization.

11. The computer-implemented method of claim 10, wherein:
one or more of the filterable containers represent business units of the enterprise organization;
one or more of the filterable containers represent employees of the enterprise organization; and
one or more of the filterable containers represent accounts of the enterprise organization.

12. The computer-implemented method of claim 11, wherein:
one or more of the filterable entities represent customers, and are linked from one or more of the filterable containers representing business units and from one or more of the filterable containers representing accounts;
one or more of the filterable containers representing employees are linked from one or more of the filterable containers representing business units; and
one or more of the filterable entities represent paychecks, and are linked from one or more of the filterable containers representing employees.

13. The computer-implemented method of claim 2, wherein substantially unique identifiers are assigned to the filterable entities and the filterable containers.

14. The computer-implemented method of claim 1, wherein the resulting set of data is determined by joining a table comprising the criteria selected by the user with a table comprising the user access rights assigned to the user.

15. A computer-readable medium comprising computer-executable instructions which, when executed by a computer, configure the computer to:
provide information indicative of a data structure;
receive a data statement from a user, the data statement comprising data statement criteria selected by the user;
apply further data statement criteria to the data statement based on a set of data access rights previously assigned to the user;
retrieve a set of filtered data, conforming to both the data statement criteria selected by the user and the further data statement criteria based on the user's data access rights, from the data structure; and
provide the user with access to the filtered data.

16. The computer-readable medium of claim 15, wherein the access rights previously assigned to the user indicate which of several filterable containers the computer is configured to retrieve data from and provide the user with access to.

17. A data system comprising:
one or more filtering criteria providers, configured to provide filter criteria associated with a data structure; and
a pluggable criteria provider, in operative communication with at least one of the filtering criteria providers, and configured to call the filter criteria from at least one of the filtering criteria providers, to join the filter criteria with criteria from a statement, and to execute the statement, thereby retrieving data indicated by the joined criteria.

18. The data system of claim 17, wherein at least one of the filtering criteria providers is configured to define a data structure incorporating contextual information, to provide the data structure to the pluggable criteria provider, and to provide the filter criteria to the pluggable criteria provider responsively to the pluggable criteria provider passing the data structure back to the filtering criteria provider.

19. The data system of claim 17, wherein the data structures defined by the filtering criteria providers comprise filterable containers, and filterable entities that are linked from the filterable containers.

20. The data system of claim 19, wherein the data structures include one or more non-secure filterable containers to which users automatically have access rights, and one or more secure filterable containers, comprising additional criteria that admit access to data associated with the secure filterable containers if access rights to the data are indicated in a role assigned to the user.
